(19) United States
(12) Patent Application Publication
(10) Pub. No.: US 2004/0265486 A1
(43) Pub. Date: Dec. 30, 2004

(54) Polarizer manufacturing method

(76) Inventors: Chih-Yu Chao, Taipei (TW); Wen-Jiunn Hsieh, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/809,567

(22) Filed: Mar. 25, 2004

(30) Foreign Application Priority Data
Jun. 26, 2003 (TW) 92117480

(51) Int. Cl. B05D 5/06

(52) U.S. Cl. 427/162; 427/372.2

(57) ABSTRACT

The present invention provides a polarizer manufacturing method. A dip-pen is stained by dichroic molecule material or birefringent material. The stained dip-pen is brought into contact with a polarizer base to transfer the materials to the polarizer base by capillarity between the dip-pen and this base.

### FIELD OF THE INVENTION

The present invention relates to a manufacturing method for forming a polarizer, and more particularly to a dip-pen nanolithography manufacturing method for forming a polarizer.

### BACKGROUND OF THE INVENTION

A polarizer is a base component of a liquid crystal display (LCD). It is a transparent plate that only permits light having a particular direction to pass therethrough. When manufacturing the LCD panel, two interlaced polarizers are used to clip the LCD panel. The main function of the two interlaced disposed polarizers is to block or to transmit the illumination light.

FIG. 1A illustrates a TN-type LCD. When a zero voltage is applied to the LCD, the liquid crystal molecule 104 can be arranged according to the arrangement orientation of the up and down glass substrates 102 and 106. When a light 110 illuminates the LCD panel and passes through the polarizer 100, the light is twisted in the arranged direction of the liquid crystal molecule 104 to pass through the polarizer 108. The pixel appears white. When a voltage is applied to the LCD, the liquid crystal molecule 104 can be arranged as shown in the FIG. 1B. When a light 110 illuminates the LCD panel and passes through the polarizer 100, the light is not twisted. Therefore, the light 110 is blocked by the polarizer 108. The pixel appears dark.

FIG. 2 illustrates a schematic diagram of a polarizer. Dichroic molecule material is used to form the conventional a polarizer. A dichroic material (such as the iodine series or the dye series) is diffused into the transparent macromolecule film (such as a PVA). Then, the transparent macromolecule film is heated and is stretched by a uniaxial stretching method to align the diffused dichroic material to form the base 200. The originally disordered PVA molecule and the absorbed dichroic material molecule can be regularized by the stretching method. Therefore, the base 200 can absorb the light parallel to it and transmit the light perpendicular to it. After finishing the base 200, two TAC films 202 are respectively adhered to the up and down surfaces of the base 200. Then, a protection film 204 is formed over a TAC film for protecting this film. Finally, an adhering layer 206 is formed over the other TAC film for adhering this film to the liquid crystal substrate. Before adhering this film, a separating film is used to protect the adhering layer 206.

The arrangement technology of the dichroic material is the key technology for manufacturing the base 200. However, it is not perfect for use in the uniaxial stretching method to regularize the dichroic material. Therefore, the optical characteristics thereof, such as the transmittance, the polarization ratio and extinction ratio, are bad for using the uniaxial stretching method to manufacture the polarizer. Moreover, the mechanical strength of the base 200 is reduced due to the stretching process. Therefore, an additional protection layer is required to intensify the mechanical strength.

### SUMMARY OF THE INVENTION

According to the above descriptions, the main object of the present invention is to provide a polarizer manufacturing method. A shear force is used to regularize the dichroic material to increase the optical characteristic.

Another object of the present invention is to provide a polarizer manufacturing method that does not use an uniaxial stretching apparatus to regularize the dichroic material. Therefore, this method provides advantages of manufacturing ease and reduced manufacturing cost.

Yet another object of the present invention is to provide a polarizer manufacturing method. According to this method, the polarizer can be formed in the panel directly. Therefore, this method can avoid defects when stamping this polarizer on the panel to improve the yield of the panel.

The present invention provides a polarizer manufacturing method. A dip-pen is stained by dichroic material or birefringent material. The stained dip-pen is brought into contact with a polarizer base. Materials are transferred to the polarizer base by the capillarity between the dip-pen and this base. Next, a drying process is performed to remove the solvent to form the dichroic thin film. Finally, a protection layer is coated on the surface of the dichroic thin film for protecting the base.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A illustrates a schematic diagram of a TN-type LCD when a zero voltage is applied to the LCD;

FIG. 1B illustrates a schematic diagram of a TN-type LCD when a non-zero voltage is applied to the LCD;

FIG. 2 illustrates a schematic diagram of a polarizer;

FIG. 3 illustrates a schematic diagram of using an Atomic Force Microscope (AFM) tip to form the polarizer according to the present invention;

FIG. 4 illustrates a enlarged diagram of using a dip-pen to transfer the dichroic molecule to a polarizer base; and

FIG. 5 illustrates a schematic diagram of the polarizer according to the present invention.

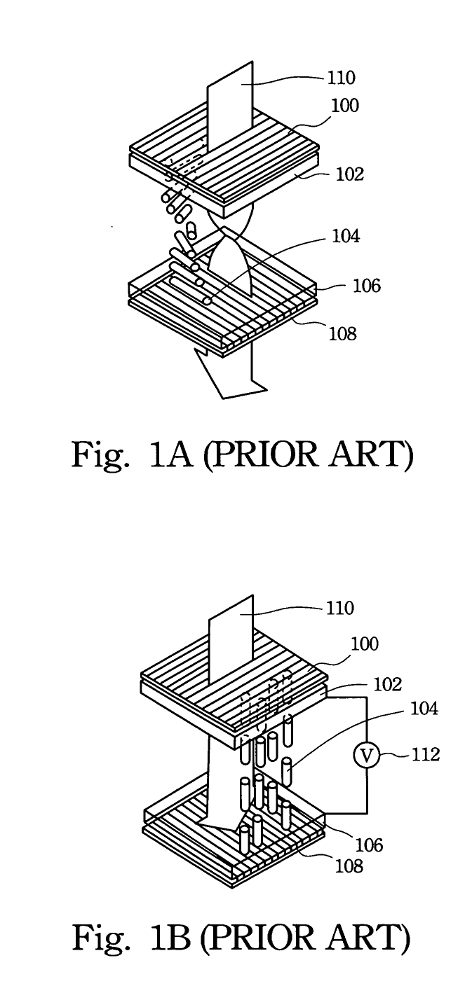

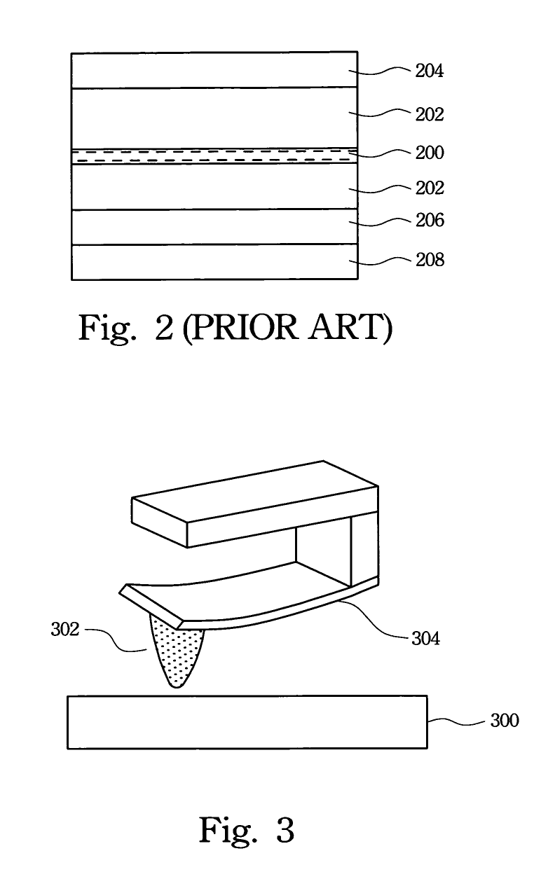

### DETAILED DESCRIPTION OF THE PREFERRED EMBODIMENT

Without limiting the spirit and scope of the present invention, the polarizer manufacturing method proposed in the present invention is illustrated with one preferred embodiment. One of ordinary skill in the art, upon acknowledging the embodiment, can apply the polarizer manufacturing method of the present invention to various liquid crystal display. Accordingly, a shear force is used to regularize the dichroic material. Therefore, the optical characteristic can be improved. Moreover, the method does not use the uniaxial stretching apparatus to regularize the dichroic material. Therefore, this manufacturing cost can be reduced. The application of the present invention is not limited by the preferred embodiments described in the following.

The polarizer manufacturing method of the present invention adopts the dip-pen nanolithography manufacturing method. The dichroic material, such as the iodine series or the dyes series, is sketched over the polarizer base by the dip-pen nanolithography method. A shear force is generated during the sketching process to regularize the dichroic molecule in a particular direction. The transparent macromolecule material or glass can be used to form the polarizer base.

The polarizer can permit a light with a particular direction to pass therethrough and isolates lights of other directions. Therefore, the polarizer requires formation of a tiny pattern on its surface. Generally, such a pattern is formed by the uniaxial stretching method. However, using the uniaxial stretching method to regularize the dichroic material is not ideal.

Therefore, the present invention uses the dip-pen nanolithography method to manufacture a polarizer. The dip-pen can use the tip of an Atomic Force Microscope (AFM) or a Scanning Tunneling Microscope. However, other types of tip can also be used in the present invention. The present invention makes a dip-pen stained by dichroic molecule material or birefringent material contact a polarizer base. The stained materials are transferred to the polarizer base by the capillarity between the dip-pen and the polarizer base.

FIG. 3 illustrates a schematic diagram of using an Atomic Force Microscope (AFM) tip to form the polarizer according to the present invention. A shaft 304 with a tip is arranged over and parallel to the polarizer base 300. This tip is used as a dip-pen 302 and is stained with dichroic molecule material or birefringent material. The coefficient of elasticity of the shaft 304 is almost equal to the force between the atoms. Therefore, when the dip-pen 302 contacts the polarizer base 300, the force between the atom in the dip-pen 302 and the atom in the surface of the polarizer base 300 can move the shaft 304 perpendicularly according the appearance of the surface of the polarizer base 300. Therefore, the distance between the dip-pen 302 and the surface of the polarizer base 300 can be fixed when transferring the stained material from the dip-pen 302 to the polarizer base 300.

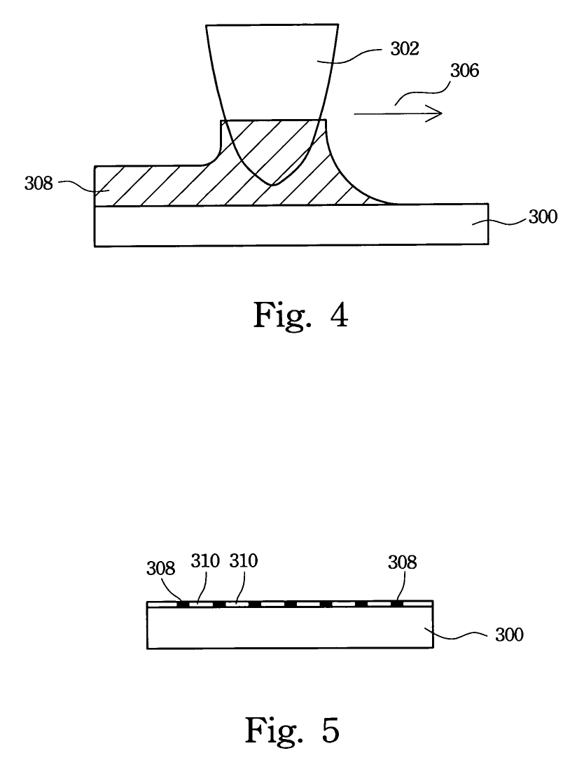

FIG. 4 is an enlarged diagram of using a dip-pen to transfer the dichroic molecule to a polarizer base. First, the dip-pen 302 is stained with the material 308. The material is a dichroic molecule material or a birefringent material. Next, the stained dip-pen 302 is brought into contact with a polarizer base 300. After that, the materials 308 are transferred to the polarizer base 300 by the capillarity between the dip-pen 302 and the base 300. The direction of movement of the dip-pen 302 is illustrated be the arrow 306. It is noted that single dip-pen 302 or a plurality of dip-pens 302 both can be used to finish the process for transferring the material 308 to the polarizer base 300.

A shear force is generated when the material 308 is transferred from the dip-pen 302 to the base 300. This molecule of the material 308 is regularized by the shear force, which can improve the regularity of the molecular arrangement. Therefore, the optical characteristic can be improved. Moreover, the method does not use the uniaxial stretching apparatus to regularize the material 308. Therefore, the manufacturing cost thereof can be reduced.

FIG. 5 illustrates a schematic diagram of the polarizer according to the present invention. After the material 308 is transferred from the dip-pen 302 to the surface of the base 300, a drying process is performed to evaporize the solvent to form the dichroic thin film. Then, a protection layer 310 is coated over the surface of the base 300 to protect the base 300. Finally, a curing process is performed to harden the protection layer 310. Then, the polarizer is finished.

Accordingly, a shear force is generated when the material is transferred from the dip-pen to the base. This shear force is used to regularize the material molecule, which is better than the conventional uniaxial stretching method to arrange the dichroic material molecule. Therefore, the mechanical strength can be maintained. Moreover, the uniaxial stretching apparatus is not necessary in the present invention, which also reduces manufacturing costs.

As is understood by a person skilled in the art, the foregoing preferred embodiments of the present invention are illustrative of the present invention rather than limiting of the present invention. It is intended that this description cover various modifications and similar arrangements included within the spirit and scope of the appended claims, the scope of which should be accorded the broadest interpretation so as to encompass all such modifications and similar structure.

What is claimed is:

1. A polarizer manufacturing method, said method comprising:
placing a material on a dip-pen;
bringing said dip-pen into contact with a base to transfer said material to said base; and
hardening said material over said base.

2. The polarizer manufacturing method according to claim 1, wherein a hardening process is used to drying said material.

3. The polarizer manufacturing method according to claim 1, wherein said material is dichroic material.

4. The polarizer manufacturing method according to claim 1, wherein said material is birefringent material.

5. The polarizer manufacturing method according to claim 1, wherein said dip-pen is a tip of an Atomic Force Microscope (AFM).

6. The polarizer manufacturing method according to claim 1, wherein said materials are transferred to the polarizer base by capillarity.

7. The polarizer manufacturing method according to claim 1, wherein a transparent macromolecule material or glass is used to form the polarizer base.

8. A polarizer manufacturing method, said method comprising:
forming a material on a dip-pen;
brining said dip-pen into contact with a base to transfer said material to said base;
hardening said material over said base;
forming a protection layer over a surface of said base; and
performing a hardening process to harden said protection layer.

9. The polarizer manufacturing method according to claim 8, wherein a hardening process is used to drying said material.

10. The polarizer manufacturing method according to claim 8, wherein said material is dichroic material.

11. The polarizer manufacturing method according to claim 8, wherein said material is birefringent material.

12. The polarizer manufacturing method according to claim 8, wherein said dip-pen is a tip of an Atomic Force Microscope (AFM).

13. The polarizer manufacturing method according to claim 8, wherein said materials are transferred to the polarizer base by capillarity.

14. The polarizer manufacturing method according to claim 8, wherein a transparent macromolecule material or glass is used to form the polarizer base.
